(19) United States
(12) Patent Application Publication
(10) Pub. No.: US 2026/0145359 A1
(43) Pub. Date: May 28, 2026

(54) METHOD FOR MODIFYING WOOD AND PRODUCTS THEREOF

(71) Applicant: RAKAUCO LIMITED, Hastings (NZ)

(72) Inventor: Paul Geoffrey DUNCAN, London (GB)

(73) Assignee: RAKAUCO LIMITED, Hastings (NZ)

(21) Appl. No.: 19/121,985

(22) PCT Filed: Aug. 4, 2020
(86) PCT No.: PCT/NZ2020/050083

§ 371 Date: Apr. 17, 2025

(30) Foreign Application Priority Data
Aug. 8, 2019 (NZ) 756157

(51) Int. Cl. B27K 3/15; B27K 3/08; B27K 3/34

(52) U.S. Cl. CPC B27K 3/15; B27K 3/083; B27K 3/343

(57) ABSTRACT

The invention relates to methods for preparing modified wood and wood products, including methods to fortify wood by increasing the strength and/or density of wood so as to yield a fortified wood or wood product. The methods can be used to, for example, improve the performance, alter the appearance, and/or improve the durability of wood, and particularly, solid wood. The methods comprise a combination of resin and thermal treatments to yield modified wood and modified wood products.

### TECHNICAL FIELD

The invention relates to methods for preparing modified wood and wood products, for example to fortify wood by increasing the strength and/or density of wood to yield a fortified wood product, for example to improve the performance, alter the appearance, and/or improve durability. In particular, the method comprises a combination of resin and thermal treatments to yield a fortified wood product.

### BACKGROUND OF THE INVENTION

The following includes information that may be useful in understanding the present inventions. It is not an admission that any of the information provided herein is prior art, or relevant, to the presently described or claimed inventions, or that any publication or document that is specifically or implicitly referenced is prior art. Any discussion of the prior art throughout the specification should in no way be considered as an admission that such prior art is widely known or forms part of the common general knowledge in the field.

There exist a number of different treatment methods which aim to increase the resistance of wood to environmental and other challenges, or to otherwise improve the durability or dimensional stability of processed wood products.

For example, chemical treatments of wood in order to increase resistance to biological degradation or deterioration, for example by wood-rot fungi, termites and the like, have been used for a long time. Some treatments are effective to provide long-term resistance to organisms that cause deterioration of the wood if applied correctly, but many of the treatments are highly toxic to mammals or the environment, and the wood so treated will frequently be unsuitable to further modification, for example increasing density or manipulation of colour or texture.

Another method to improve the resistance of wood is by thermally modifying the wood at high temperatures. During heat modification, organic compounds present in the wood are removed, and this is believed to render the wood less able to support fungal growth and/or less palatable or desirable to insects. Heat modification can also alter wood moisture, for example by imparting lower equilibrium moisture content, less moisture deformation, or improved weather resistance. However, a potential downside of thermally modified wood is the reduction in strength observed in the final product, both in tensile strength or rigidity, and in surface hardness and resistance to surface deformation. This reduction in strength can limit the applications to which the heat-treated wood can be put, and likewise can reduce the useful service life of the heat-treated material.

There exist processes to impregnate timber with resins and then subject the impregnated wood to kiln or platen heating to reduce moisture content and cure the impregnated resin. These processes are limited by the starting moisture content of the wood, the duration of heating, the nature and/or toxicity of the chemistries used and the resulting emissions, and the nature of the final product.

Thus, while a number of wood hardening procedures are commercially available, these processes have one or more performance limitations, such as but not limited to extended processing duration, limitations relating to batch processing, the need for large quantities of resins and other compounds for moisture reduction or impregnation, wastage, the production of wood products having reduced strength or increased brittleness, an inability to modify product density or manage the colour of the final product.

The methods and products described herein possess one or more beneficial characteristics.

It is therefore an object of the invention to provide a method of treating wood which overcomes one or more of the limitations identified above, and/or a method capable of producing a modified wood or modified wood product, including a modified wood or modified wood product having one or more of desired density, colour, durability, texture, or processability, and/or to at least provide the public with a useful choice.

### SUMMARY OF THE INVENTION

In a first aspect the invention relates to a wood treatment process comprising:
a) Selecting and grading wood suitable for treating;
b) Mixing resins and optionally colour with water to make to make a resin-impregnating composition to achieve the desired performance and appearance attributes;
c) subjecting wood to a reduced pressure in a pressure vessel;
d) immersing the wood in the resin-impregnating composition;
e) subjecting the resin-impregnated wood to a direct or indirect drying process.

In another aspect the invention relates to a method of treating wood, the method comprising:
a) providing wood suitable for treating;
b) contacting the wood with an aqueous resin composition while the wood is maintained at a pressure below atmospheric pressure;
c) heating the wood;
to yield a treated wood or wood product.

Any of the embodiments described herein can relate to any of the aspects presented herein.

In one embodiment, the invention relates to a method of treating wood, the method comprising:
b) providing an aqueous resin composition;
c) maintaining the wood at reduced pressure;
d) contacting the wood with the aqueous resin composition;
e) heating the wood;
to yield a treated wood or wood product.

In another embodiment, the method of treating wood comprises:
a) providing wood suitable for treating;
b) contacting the wood with an aqueous resin composition while the wood is maintained at a pressure below atmospheric pressure;
c) heating the wood at a first heating temperature below the boiling point of water;
d) heating the wood at a temperature effective to torrefy the wood;
to yield a treated wood or wood product.

In another embodiment, the method of treating wood comprises:
a) providing wood suitable for treating;
b) contacting the wood with an aqueous resin composition while the wood is maintained at a pressure below atmospheric pressure;
c) heating the wood at a first heating temperature below the boiling point of water;
d) heating the wood at a temperature effective to torrefy at least about 20% of the lignocellulose present in the wood;
to yield a treated wood or wood product.

In another aspect the invention relates to a method of treating wood, the method comprising:
a) providing wood suitable for treating;
b) maintaining the wood for a first period at a pressure of from about 0.7 to about 1.0 bar;
c) contacting the wood with an aqueous resin composition while the wood is at a pressure of from less than 1 bar to about 0.7 bar;
d) maintaining the wood for a second period at a pressure of from more than 1 bar to about 15 bar;
e) maintaining the wood for a third period at a pressure of from about 0.7 to about 1.0 bar; and
f) heating the wood.

In various embodiments, the suitability of the wood is determined by grading and/or selecting wood, for example, shortly before or during step a).

In various embodiments, the suitability of the wood is determined by reference to information associated with the wood, for example, an identification tag, marker, information sheet, colour, bar code, RFID, or the like.

In various embodiments, the wood is contacted with the resin by immersion or by spraying.

In one embodiment, the wood is maintained at a pressure below atmospheric pressure in a pressure vessel. In various embodiments, the wood is maintained, for example for the first period, for the second period, or for the third period, or any combination thereof, in a pressure vessel.

It will be appreciated on reading this disclosure that in certain embodiments the pressure at which the wood is maintained in each of the specified periods will be the same, for example, for ease of process management or plant requirements. In other embodiments, the pressure at which the wood is maintained in one or more of the specified periods will be different, for example, to accommodate the different processes that take place in each of the different periods. Those skilled in the art will recognise on reading this disclosure that factors such as the species and cut of wood being processed, the nature of the resin being used, the desired finish and/or other final characteristics of the wood product desired will usually influence process parameters, including the pressure maintained during one or more of the specified periods.

In various embodiments, the method comprises maintaining the wood for one or more periods at a pressure below atmospheric pressure, generally being a pressure of less than 1 bar, for example, at a pressure of less than 1 bar to about 0.1 bar. In certain embodiments, the method comprises maintaining the wood for one or more periods at a pressure of less than 1 bar to about 0.2 bar, or at a pressure of less than 1 bar to about 0.3 bar, or at a pressure of less than 1 bar to about 0.4 bar, for example, at a pressure of less than 1 bar to about 0.5 bar, at a pressure of less than 1 bar to about 0.6 bar, or more commonly at a pressure of less than about 1 bar to about 0.7 bar. In still further embodiments, for one or more of the first period, the second period, the third period, or any combination of two or more thereof, the wood is maintained at a pressure of from less than 1 bar to about 0.8 bar, or from less than about 1 bar to about 0.9 bar.

In various embodiments, the method comprises maintaining the wood for a third period at a pressure of from about 0.7 to about 0.9 bar, for example, at a pressure of about 0.8 bar.

For example, in embodiments comprising maintaining the wood for a first period at a pressure of from about 0.7 to about 1.0 bar, and/or comprising maintaining the wood for a third period at a pressure of from about 0.7 to about 1.0 bar, the wood is maintained under vacuum in a pressure vessel. It will be understood that pressures below atmospheric pressure are conveniently achieved using a vessel which can be at least partially evacuated, for example, by vacuum.

In various embodiments, the method comprises maintaining the wood for a first period at a pressure of from about 0.7 to about 0.9 bar, for example, at a pressure of about 0.8 bar In various embodiments, the method comprises maintaining the wood for a third period at a pressure of from about 0.7 to about 0.9 bar, for example, at a pressure of about 0.8 bar.

In various embodiments, the wood is contacted with the aqueous resin for a period sufficient to allow saturation of the wood with the aqueous resin. For example, the wood is contacted with the aqueous resin for a period sufficient to ensure no further uptake of aqueous resin into the wood occurs, that is, total saturation.

In one embodiment, the wood is contacted with the aqueous resin for a period of at least about 1 hour, at least about 2 hours, at least about 6 hours, at least about 12 hours, or more than about 12 hours.

In various embodiments, the aqueous resin is a resin selected from the group consisting of phenolic resins, phenol-formaldehyde urea resins, novolac resins, and resole resins.

In one embodiment, the aqueous resin is a phenoplast resin.

In various embodiments, the phenoplast resin has a solids content of from about 1% w/w to about 50% w/w of the aqueous resin composition, for example, from about 5% w/w to about 50% w/w of the aqueous resin composition.

In various embodiments, the aqueous resin comprises a colourant, such as a dye or a pigment.

In one embodiment, the wood is maintained at a pressure below atmospheric pressure for a period of at least about 1 hour, at least about 2 hours, at least about 6 hours, at least about 12 hours, or more than about 12 hours.

In various embodiments, the first period, the second period, the third period, or any two or more thereof, is at least about 1 hour, at least about 2 hours, at least about 6 hours, at least about 12 hours, or more than about 12 hours.

In a further embodiment, the wood is pre-coloured prior to being subjected to a pressure other than atmospheric pressure, for example prior to being subjected to a pressure below atmospheric pressure, or prior to being introduced into a pressure vessel.

In one embodiment, the wood is dried at least until it has a moisture content of about 95% or less that of the moisture content of the wood prior to modification.

In various embodiments, the wood is dried by heating at a temperature of from about 70° C. to about 320° C.

In various embodiments, the wood is subjected to direct heating in contact with a surface heated at from about 70° C. to about 320° C.

In various embodiments, the wood is subjected to direct heating at a temperature sufficient to have the temperature at the centre of the wood to be from about 70° C. to about 320° C.

In one embodiment, the wood is dried by heating in direct contact with a heated surface, for example, a platen drier or press, or a lineal drier, including a multistage lineal drier.

In various embodiments, heating the wood comprises
a) maintaining the wood for a first heating period at a temperature below about 100° C., for example, at a temperature of from about 70° C. to about 100° C.;
b) maintaining the wood for a second heating period at a temperature above about 200° C., for example from about 200° C. to about 320° C.

In various embodiments, heating the wood comprises
a) maintaining the wood for a first heating period at a temperature of from about 70° C. to about 320° C.;
b) maintaining the wood for a second heating period at a temperature of from about 70° C. to about 320° C.

In various embodiments, heating the wood comprises
a) maintaining the wood for a first heating period at a temperature of from about 70° C. to about 320° C.;
b) maintaining the wood for a second heating period at a temperature of from about 70° C. to about 320° C.;
c) maintaining the wood for a third heating period at a temperature of from about 70° C. to about 320° C.

In one example, heating the wood comprises
a) maintaining the wood for a first heating period at a temperature sufficient to have the temperature at the centre of the wood to be from about 70° C. to about 320° C.;
b) maintaining the wood for a second heating period at a temperature sufficient to have the temperature at the centre of the wood to be from about 70° C. to about 320° C.;
c) maintaining the wood for a third heating period at a temperature sufficient to have the temperature at the centre of the wood to be from about 70° C. to about 320° C.

Accordingly, in one embodiment, the method of treating wood comprises:
a) providing wood suitable for treating;
b) maintaining the wood for a first period at a pressure of from less than 1 bar to about 0.7 bar;
c) contacting the wood with an aqueous resin composition while the wood is at a pressure of from less than 1 bar to about 0.7 bar;
d) maintaining the wood for a second period at a pressure of from more than 1 bar to about 15 bar;
e) maintaining the wood for a third period at a pressure of from less than 1 bar to about 0.7 bar; and
f) heating the wood by
g) maintaining the wood for a first heating period at a temperature of from about 70° C. to about 320° C.;
h) maintaining the wood for a second heating period at a temperature of from about 70° C. to about 320° C.;
i) maintaining the wood for a third heating period at a temperature of from about 70° C. to about 320° C.

In various embodiments, heating the wood comprises
a) maintaining the wood for a first heating period at a temperature of from about 70° C. to about 100° C.;
b) maintaining the wood for a second heating period at a temperature of from about 100° C. to about 200° C.;
c) maintaining the wood for a third heating period at a temperature of from about 200° C. to about 320° C.

In one example, heating the wood comprises
a) maintaining the wood for a first heating period at a temperature sufficient to have the temperature at the centre of the wood to be from about 70° C. to about 100° C.;
b) maintaining the wood for a second heating period at a temperature sufficient to have the temperature at the centre of the wood to be from about 100° C. to about 200° C.;
c) maintaining the wood for a third heating period at a temperature sufficient to have the temperature at the centre of the wood to be from about 200° C. to about 320° C.

In various embodiments, the wood is maintained at from about 200° C. to about 320° C., or is maintained at a temperature sufficient to have the temperature at the centre of the wood to be from about 200° C. to about 320° C., for a period sufficient to
a) de-hydrolyse or degrade at least about 25% w/w of the lignocellulose present in the wood prior to contact with the aqueous resin composition; or
b) degrade at least about 25% w/w of the cellulose present in the wood prior to contact with the aqueous resin composition; or
c) degrade at least about 25% w/w of the hemicellulose present in the wood prior to contact with the aqueous resin composition; or
d) degrade at least about 25% w/w of the lignin present in the wood prior to contact with the aqueous resin composition; or
e) remove at least about 10% of the volatiles present in the wood prior to contact with the aqueous resin composition; or
f) any combination of two or more of any of a) to e) above.

In one embodiment, heating the wood comprises subjecting the wood to a platen heating process, wherein the platen heating process comprises contacting at least one face of the wood with a heated surface, for example, the process comprises contacting two opposing faces of the wood with heated surfaces. In certain embodiments, the platen heating process comprises applying pressure to the wood, for example, sufficient pressure to prevent the deformation of the wood during heating.

In some embodiments, the platen heating process comprises
a) maintaining the wood for a first heating period at a temperature sufficient to have the temperature at the centre of the wood to be from about 70° C. to about 100° C.;
b) maintaining the wood for a second heating period at a temperature sufficient to have the temperature at the centre of the wood to be from about 100° C. to about 150° C.;
c) maintaining the wood for a third heating period at a temperature sufficient to have the temperature at the centre of the wood to be from about 200° C. to about 320° C.

In certain embodiments, the platen heating process applies hot plates to opposing faces of the wood and pressure is applied, wherein the pressure required will vary depending upon the species being dried.

In some embodiments, the wood is moved through opposing hot plates on a conveyor with the temperature of the plates increasing from the first, to second, then third value as the wood progresses along the conveyor. In one embodiment, the wood is continuously heated in contact with a contiguous platen surface.

In another embodiment, the wood is moved along a continuous conveyor from one heating station to another heating station, wherein the wood is maintained at each station for the requisite period. In one such embodiment, the one or more of the heating stations are not contiguous. In one such embodiment, one or more of the heating stations may be held at its operational temperature, for example to improve efficiency, but is positioned so as not to contact the wood, thus to allow for different heating periods without moving the wood from the station. It will be appreciated that such an arrangement allows for the simultaneous processing of multiple batches of wood in a continuous process, for example on a continuous conveyor, at different temperatures and for different heating periods, when required.

Accordingly, in one embodiment, the method of treating wood comprises:
a) providing wood suitable for treating;
b) maintaining the wood for a first period at a pressure of from less than 1 bar to about 0.7 bar;
c) contacting the wood with an aqueous resin composition while the wood is at a pressure of from less than 1 bar to about 0.7 bar;
d) maintaining the wood for a second period at a pressure of from more than 1 bar to about 15 bar;
e) maintaining the wood for a third period at a pressure of from less than 1 bar to about 0.7 bar; and
f) heating the wood by
g) contacting the wood for a first heating period with a set of opposing plates at a temperature of from about 70° C. to about 100° C.;
h) contacting the wood for a second heating period with a set of opposing plates at a temperature of from about 100° C. to about 200° C.;
i) contacting the wood for a third heating period with a set of opposing plates at a temperature of from about 200° C. to about 320° C.

In one embodiment, for the first heating period the wood is contacted with a first set of opposing plates, for example, the wood is contacted with a first set of opposing plates configured to apply pressure to opposing faces of the wood.

In one embodiment, for the second heating period the wood is contacted with a second set of opposing plates, for example, the wood is contacted with a second set of opposing plates configured to apply pressure to opposing faces of the wood.

In one embodiment, for the third heating period the wood is contacted with a third set of opposing plates, for example, the wood is contacted with a third set of opposing plates configured to apply pressure to opposing faces of the wood.

Another aspect of the present invention relates to a modified wood product produced by a method as described herein.

In a further aspect, the present invention relates to a modified wood or wood product comprising a resin, wherein the modified wood or wood product
a) comprises at least about 5% w/w of one or more by-products of pyrolysis or torrefaction, or
b) comprises at least about 10% w/w lignocellulose, wherein at least about 25% w/w of the lignocellulose is de-hydrolysed; or
c) comprises at least about 10% w/w lignocellulose, wherein at least about 25% of the cellulose present in the wood prior to modification is degraded; or
d) comprises at least about 10% w/w lignocellulose, wherein at least about 25% of the hemicellulose present in the wood prior to modification is degraded; or
e) comprises at least about 10% w/w lignocellulose, wherein at least about 25% of the lignin present in the wood prior to modification is degraded; or
f) has a volatiles content of at least about 10% w/w less than the volatiles content of the wood prior to modification; or
g) any combination of two or more of any of a) to f) above.

In one embodiment, the modified wood or wood product comprises lignocellulose, wherein at least about 30% of the hemicellulose present in the wood prior to modification is degraded. For example, at least about 35% of the hemicellulose present in the wood prior to modification is degraded, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% of the hemicellulose present in the wood prior to modification is degraded. In one embodiment, substantially all of the hemicellulose present in the wood prior to modification is degraded.

In one embodiment, with respect to the starting material the modified wood such as the modified wood comprising a wood product has one or more of the following:
a) increased density;
b) decreased moisture by at least about 6%;
c) increased tensile strength;
d) increased hardness;
e) increased weather resistance;
f) managed colour;
g) increased durability;
h) improved fire resistance;
i) any combination of two or more of any of a) to h) above.

In a further aspect of the present invention relates to a product comprising wood produced by a method as described herein.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7). These are only examples of what is specifically intended and all possible combinations of numerical values between the lowest value and the highest value enumerated are to be considered to be expressly stated in this application in a similar manner.

Those skilled in the art will appreciate the meaning of various terms of degree used herein. For example, as used herein in the context of referring to an amount (e.g., “about 9%”), the term “about” represents an amount close to and including the stated amount that still performs a desired function or achieves a desired result, e.g. “about 9%” can include 9% and amounts close to 9% that still perform a desired function or achieve a desired result. For example, the term “about” can refer to an amount that is within less than 10% of, within less than 5% of, within less than 1% of, within less than 0.1% of, or within less than 0.01% of the stated amount. It is also intended that where the term “about” is used, for example with reference to a figure, concentration, amount, integer or value, the exact figure, concentration, amount, integer or value is also specifically contemplated.

Other objects, aspects, features and advantages of the present invention will become apparent from the following description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIG. 1 depicts a representative example of a plant suitable for processing wood and wood products in accordance with the methods described herein.

### DETAILED DESCRIPTION

The present invention relates to a method of treating wood, particularly resin-impregnated wood, by torrefaction, where the treatment improves one or more characteristics of the wood. For example, the treated wood in certain embodiments has improved durability, increased density, better performance, more durable colour, and the like, as a result of the treatment method.

Broadly, the method involves subjecting the resin-impregnated wood to a heating process that includes heating at temperatures above 200° C. This heating process removes water, cures the resin, and torrefies the wood fibre to produce a modified wood product having desired functional and/or aesthetic performance.

The method described herein includes processing at temperatures between 200° C. 320° C. to improve the durability of the wood fibre via torrefaction, and curing (for example, cross linking) an aqueous resin impregnated into the wood, which is selected to provide one or more advantageous or desired characteristic to the final product, such as, variously, added weight and/or density, increased strength, increased hardness, improved stability, improved resistance to fire, and/or improved colour management or durability.

Thus, the invention generally relates to a method of treating wood, the method comprising:
a) providing wood suitable for treating;
b) contacting the wood with an aqueous resin composition while the wood is maintained at a pressure below atmospheric pressure;
c) heating the wood;
to yield a treated wood or wood product.

The heating process will typically employ heating the resin-impregnated wood for a given period at each of two or more temperatures.

Without wishing to be bound by any theory, the first heating period with a value below 100° C. seeks to begin the gentle movement of water from the wood without over stressing the wood fibres and to allow the resin to gel. A further heating period, usually at a higher temperature, is employed in certain embodiments to accelerate this process.

The heating process will typically comprise a further heating period in which the resin-impregnated wood is heated for a period at a temperature above 200° C., once excess water has been removed from the wood, so as to torrefy the wood and to ensure a full resin cure.

As used herein, the term “torrefy” as used herein refers to the process of subjecting a material, in the present instance wood, particularly resin-impregnated, at least partially dried wood, to heat, typically in the range of 200° C. to about 320° C. The related terms “torrefaction” and “torrefied” will be similarly understood. Generally, torrefaction of wood and other lignocellulosics results in the removal of water and various volatile compounds, and the at least partial degradation of cellulose, hemicellulose, and/or lignin in the wood or lignocellulosic material.

In certain embodiments, torrefaction of wood carried out at temperatures at or above about 300° C. is effective to degrade the majority of hemicellulose present in the wood, and in certain embodiments is effective to degrade more than 90% of the hemicellulose initially present in the wood.

Methods to determine the degree of torrefaction are known in the art, and include methods involving acid hydrolysis followed by analysis of glucan, mannan, and galactan by, for example, high performance liquid chromatography. Related methods, for example to measure remaining lignin, include the well-known Klason lignin/acid-soluble lignin test.

Those skilled in the art will understand, on reading this disclosure, that the methods described herein can be achieved using kilns including high temperature kilns suitable for creating thermally modified timber (TMT), particularly those kilns relying on RAM air in a reduced air or reduced oxygen environment, or RAM air kilns with pressure, or by direct heat using a platen drier, such as a lineal multistage drier, to achieve the temperatures required to achieve torrefaction and resin cure.

In one embodiment, the heating is performed in a stationary pyrolysis plant, for example a stationary pyrolysis plant able to operate in a closed cycle, such as a plant that provides for substantially complete combustion of pyrolysis gases in the plant. In certain embodiments, the drying, torreation and curing processes in the plant are aligned.

In certain embodiments, the vapour, steam and/or gases formed in the treatment method are completely collected in one or more volatiles collectors, and may, for example, be discharged into the heating chamber and burnt. As a consequence, the emission of exhaust volatiles is minimised.

It will be appreciated that accurate process control, for example, accurate control of heating temperature and duration, are beneficial if not essential to the production of high quality modified wood products. Those skilled in the art will be aware of a variety of control systems and equipment, such as thermocouples or other temperature sensors to provide temperature measurement and temperature control, moisture probes and sensors to monitor moisture content, for example within the wood prior to or undergoing treatment, or the moisture of waste gases or volatiles, which can for example transmit data to a central processor, a display, a control panel, or the like. For example, in certain embodiments, thermocouples and/or moisture sensors are located at the inlet and outlet of the heating chamber, or for example in the flue to measure the exhaust or input gases from/to the heating and/or drying chambers.

In one representative embodiment of a process employing a kiln, resin-impregnated wood is first stacked with spacing sticks between each board to allow airflow in the kiln. The stacks of wood are then loaded into the pyrolysis kiln which is set to measure EMC using wood wafers and probes fixed into the wet timber to monitor moisture content. Probes and sensors are connected back to the kiln control unit that operates to a predetermined schedule to produce resin cure and conditioning the timber to the required final moisture content.

Typically, kiln processes involve the evolution of volatiles, such that in certain embodiments the vapor-gas mixture formed during heating is collected in a volatiles collector and passed back into the kiln from the volatiles collector through a volatiles discharge conduit, where it can be burnt, reducing energy expenditure and emissions.

In certain embodiments, for example in embodiments in which a kiln is employed for one or more of the heating steps, the wood is dried in a press drier.

In particularly contemplated embodiments, a platen drier is used to heat the wood and/or cure the resin, or both.

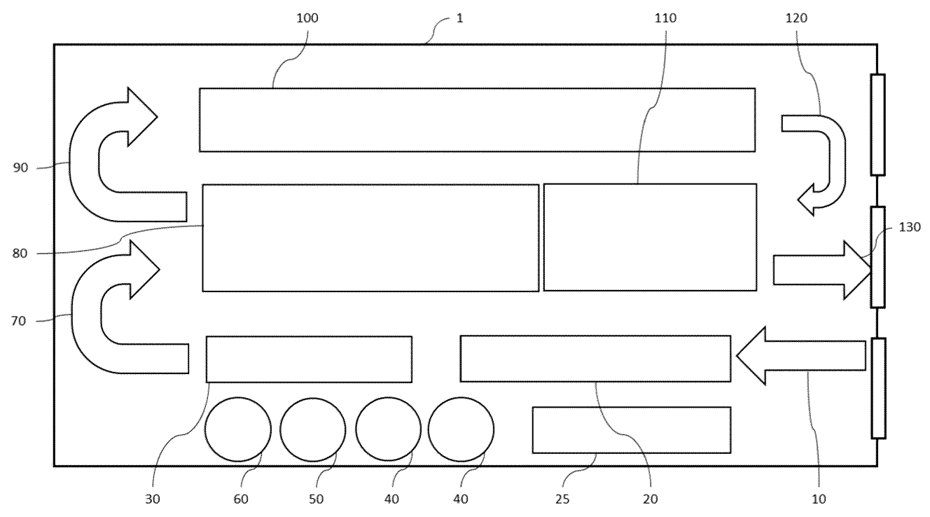

One representative embodiment of a plant comprising a platen drier and suitable for use in a method as described herein in shown in FIG. 1.

The modified wood processing plant 1 enables incoming wood feedstock 10 to be stored in a feedstock storage 20 if necessary prior to entry into the modification process.

The feedstock storage 20 is suitable for wood grading and/or selection/rejection, for example, under the control of a process control station 25, if needed. Wood to be treated is introduced into the pressure vessel 30. Resin is also introduced into the pressure vessel 30, either directly from one or more holding tanks 40, or from a mixing tank 50 in which a concentrated resin is diluted to the desired solids content or concentration using water from a water tank 60. The pressure vessel is held at the required pressures as described herein, whereupon the resin-impregnated wood is introduced via a covenyor 70 to a first platen stage 80 for conditioning, heating, and curing. Depending on the processing conditions, for example, the process selected by the process control station 25 or modified in response to one or more inputs received during processing, the heated and cured modified wood is either transferred via a conveyor 90 to a drying stage 100 for heating and drying, or directly to a machining stage 110 for finishing. Modified wood from the drying stage 100 is transferred via a conveyor 120 to the machining stage 110 for finishing. Finished modified wood 130 is then ready for storage and/or distribution.

Platen driers suitable for use in the methods described herein are known in the art, and in certain embodiments include a platen drier used to make panel products and sheet material, such as equipment made by Siempelkamp GmbH & Co or Dieffenbacher GmbH & Co. It will be appreciated that a platen drier capable of achieveing one or more of the temperatures employed in the methods described herein is contemplated. However, in certain embodiments, a platen drier is employed for one or more lower temperature steps, for example, the first and/or second heating periods, and one or more of the higher temperature steps, such as the third heating period, employs different equipment, such as a kiln.

In one particularly contemplated embodiment, the platen heating process comprises
a) maintaining the wood for a first heating period at a temperature sufficient to have the temperature at the centre of the wood to be from about 70° C. to about 100° C.;
b) maintaining the wood for a second heating period at a temperature sufficient to have the temperature at the centre of the wood to be from about 100° C. to about 150° C.;
c) maintaining the wood for a third heating period at a temperature sufficient to have the temperature at the centre of the wood to be from about 200° C. to about 320° C.

In various embodiments, the methods described herein have minimal environmental impact, in that they provide for substantially complete combustion of the mixture of volatiles evolved from the resin-impregnated wood during heating, torrefaction, and curing, or in that they provide for ready containment of the drying/torrefaction/curing process within, for example, a continuous or multistage platen drier, thereby enabling the ready control of emissions.

### Woods

Various species can be used in the process of the invention, including softwoods (such as pine and the like) and hardwoods (such as beech and the like). Woods for treating will generally not have any corewood, as this often will not accept aqueous compounds. Depending on the use to which the modified wood is to be put, in particularly contemplated embodiments the wood is without knots or other imperfections.

Not all wood is suitable for treatment using the methods described herein. Species that are suitable include, but are not limited to: Albizzia Balsa Iroko (Chlorophora excelsa), Jelutong (Dyera costulata), Merbau (Intsia palembacia), Tawa (Beilschmiedia tawa), Radiata Pine (Pinus radiata), European Beech (Gagus syivatica), Cotton Wood (Populus deltoids), Aspen (Populus tremuloides), Rubber Wood (Hevea brasiliensis), Birch (Betula alleghaniensis), Baltic Pine (Pinus sylvestris), Ponderosa Pine (Pinus ponderosa), Hoop Pine (Araucaria cunninghamii), Caribbean Pine (Pinus caribaea), Loblolly Pine (Pinus taeda), Southern Yellow Pine (Pinus rigida), Hemlock (Tsuga canadensis), Western Juniper (Juniperus occidentalis), Poplar (Liriodendron tulipifera), Willow (Salix nigra), Slash Pine (Pinus elliottii), White Pine (Pinus strobes), Poplar Hybrid (Populus dehoidesXnigra), Corsican Pine (Pinus nigra subsp. laricio)

### Resins

Those skilled in the art will recognise that a number of resins suitable for the modification of wood exist, employing different chemistries, polymerising and curing agents or modes (e.g., UV exposure, heat, pH), and suitable for differing end uses.

In certain embodiments, one or more resins is selected so as to provide one or more advantageous characteristic in the final product, such as one or more of increased density, increased strength, increased durability, increased fire resistance, desired colour, or improved processibility.

In various embodiments, the one or more characteristics is increased or improved with respect to the comparable characteristic in the starting wood material prior to processing.

Those skilled in the art will recognise that a number of different classes of wood-impregnating resins are commercially available, and can be selected on the basis of the desirable characteristic(s) to be conferred on the final modified wood product, the method of manufacturing, and the use to which the wood product is to be put, among other considerations.

In one embodiment, the resin is selected from the group comprising phenoplasts, polymeric diisocyanates, melamine resins, resorcinol resins, polyvinyl acetate resins, and hybrid thermoset compounds.

In one embodiment, the aqueous resin is a phenoplast resin.

In one embodiment, the aqueous resin is a phenoplast resin selected from the group consisting of phenolic resins, phenol-formaldehyde urea resins, novolac resins, and resole resins.

In one embodiment, the resin is an aqueous phenoplast resin. In one example, the aqueous phenoplast resin has a solids content of from about 1% w/w to about 50% w/w of the resin composition, for example, from about 5% w/w to about 50% w/w of the resin composition, from about 10% w/w to about 50% w/w, from about 15% w/w to about 50% w/w, from about 20% w/w to about 50% w/w, from about 25% w/w to about 50% w/w, from about 30% w/w to about 50% w/w, from about 35% w/w to about 50% w/w, from about 40% w/w to about 50% w/w, or from about 45% w/w to about 50% w/w of the resin composition.

Commercially available resins suitable for use herein include phenoplast resins from Hexion (OH, USA), AICA, Huntsman, or ICA (Italy).

In some embodiments, the aqueous resin composition comprises an additive selected from the group comprising one or more colourants, pigments, fire retardants, or other additives the presence of which provides one or more desired characteristics in the modified wood product.

It will be appreciated that additives suitable for use herein are those able to retain useful functionality under the processing conditions employed herein. For example, the one or more additives are able to retain useful functionality at the pH of the aqueous resin, and are able to retain useful functionality at the temperatures at which the wood product is maintained during the methods described herein, including temperatures up to about 320° C. Particularly contemplated are colourant and pigments capable of withstanding the alkalinity of the aqueous resin composition and the heat treatement process, without losing the colour contributing characteristics for which it has been selected, including the durability of colour in the final product, particularly when that product is exposed to exterior environmental conditions.

It will be appreciated that a great variety of modified wood products suitable for a range of applications can be prepared using the methods described herein. The final application to which the wood is to be put will typically influence the species and cut of wood, the aqueous resin chosen, the presence of any additives, and/or the specific parameters employed during the different steps of the method.

The wood processed by the methods described herein is particularly robust, and well-suited to outdoor/exposed use. In certain embodiment, the modified wood is turned into a variety of outdoor products such as garden decking, but also products which have hitherto been formed from expensive wood, e.g. decking material for pleasure boats, decorative interior cladding and durable exterior cladding. The dimensional stability of the wood products produced by embodiments of the methods described herein, particularly those in which a platen heating process is employed, render the modified wood products suitable for a range of applications where such stability is important or critical.

The invention is further described with reference to the following examples. It will be appreciated that the invention as claimed is not intended to be limited in any way by these examples.

### EXAMPLES

### Example 1: Processing Method Using a Kiln

This example describes the preparation of a modified wood product via a processing method as contemplated herein.

A batch of sapwood boards of dried sawn solid pine wood is first placed in a pressure vessel and the vessel evacuated to about 0.8 bar vacuum.

An aqueous phenolic resole resin composition comprising a temperature stable pigment is then introduced into the evacuated vessel. The vessel is then pressurised to about 15 bar for about 1 hour so as to impregnate all the boards through to the centre board. The vessel is then evacuated briefly to about 0.8 bar, whereupon the wood is removed from the vessel.

The impregnated boards are transferred to a TMT kiln and heated for a period of 1 hour at 90° C., then the temperature of the kiln is raised to 120° C. and held for 1 hour, and finally the temperature of the kiln is raised to 320° C. and held for 2 hours to effect torrefaction and full resin cure.

The process reduces the final moisture content of the wood to between 6%-16%, resulting in a modified wood product with improved hardness and strength. As the phenolic resole resin has fire retardancy properties, the fully cured modified wood will have improved resistance to fire compared with untreated wood.

### Example 2: Processing Method Using Multi-stage Platen Drier

This example describes the preparation of a modified wood product via a processing method as contemplated herein.

A batch of sapwood boards of dried sawn solid beech wood is first placed in a pressure vessel and the vessel evacuated to about 0.9 bar vacuuum.

An aqueous phenolic resole resin composition comprising a temperature stable dye is then introduced into the evacuated vessel. The vessel is then pressurised to about 12 bar for 2 hours so as to impregnate all the boards through to the centre board. The vessel is then evacuated briefly to about 0.8 bar, whereupon the wood is removed from the vessel.

The impregnated boards are transferred to a continuous platen system comprising three platen stations, each station comprising a pair of opposing heated plates. The wood is conveyed to a first platen station heated at 85° C. and is held for 2 hours. The wood is then conveyed to a second platen station having a temperature of 140° C. and is maintained 1 hour. Finally, the wood is conveyed to a third platen station having a temperature of 300° C. and is held for 2 hours to effect torrefaction and full resin cure.

The process reduces the final moisture content of the wood to between 6%-16%, resulting in a modified wood product with improved hardness and strength. As the phenolic resole resin has fire retardancy properties, the fully cured modified wood will have improved resistance to fire compared with untreated wood.

Furthermore, because the boards are pressed by hot plates during drying, torrefaction and resin cure, the boards do not deform during processing, providing a dimensionally stable product amenable to downstream processing, or direct use.

As used in this specification, the words “comprise”, “comprises”, “comprising”, and similar words, are not to be interpreted in an exclusive or exhaustive sense. In other words, they are intended to mean “including, but not limited to”. When interpreting each statement in this specification that includes the term “comprise”, “comprises”, or “comprising”, features other than that or those prefaced by the term may also be present.

The entire disclosures of all applications, patents and publications cited above and below, if any, are herein incorporated by reference.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

The invention may also be said broadly to consist in the parts, elements and features referred to or indicated in the specification of the application, individually or collectively, in any or all combinations of two or more of said parts, elements or features.

Aspects of the invention have been described by way of example only, and it should be appreciated that variations, modifications and additions may be made without departing from the scope of the invention, for example when present the invention as defined in the indicative claims. Furthermore, where known equivalents exist to specific features, such equivalents are incorporated as if specifically referred in this specification.

1-24. (canceled)

25. A method of treating wood comprising:
a) providing wood suitable for treating;
b) maintaining the wood for a first period at a pressure of from less than 1 bar to about 0.7 bar;
c) contacting the wood with an aqueous resin composition while the wood is at a pressure of from less than 1 bar to about 0.7 bar;
d) maintaining the wood for a second period at a pressure of from more than 1 bar to about 15 bar;
e) maintaining the wood for a third period at a pressure of from less than 1 bar to about 0.7 bar; and
f) heating the wood by
i. maintaining the wood for a first heating period at a temperature of from about 70° C. to about 320° C.;
ii. optionally maintaining the wood for a second heating period at a temperature of from about 70° C. to about 320° C.;
iii. maintaining the wood for a further heating period at a temperature of from about 70° C. to about 320° C.

26. The method of claim 25 wherein heating the wood comprises:
a) maintaining the wood for a first heating period at a temperature of from about 70° C. to about 100° C.;
b) optionally maintaining the wood for a second heating period at a temperature of from about 100° C. to about 200° C.;
c) maintaining the wood for a further heating period at a temperature of from about 200° C. to about 320° C.

27. The method of claim 25 wherein heating the wood comprises:
a) maintaining the wood for a first heating period at a temperature sufficient to have the temperature at the centre of the wood to be from about 70° C. to about 100° C.;
b) maintaining the wood for a second heating period at a temperature sufficient to have the temperature at the centre of the wood to be from about 100° C.to about 200° C.;
c) maintaining the wood for a third heating period at a temperature sufficient to have the temperature at the centre of the wood to be from about 200° C. to about 320° C.

28. The method of claim 25 wherein the heating comprises heating the wood at a temperature and for a period effective to torrefy at least about 20% of the lignocellulose present in the wood.

29. The method of claim 25 wherein the drying comprises heating the wood at a temperature below the boiling point of water.

30. The method of claim 25 wherein the step of heating the wood comprises contacting the wood with a platen drier.

31. The method of claim 25, wherein the heating comprises:
a) contacting the wood for a first heating period with a set of opposing plates at a temperature of from about 70° C. to about 100° C.;
b) optionally contacting the wood for a second heating period with a set of opposing plates at a temperature of from about 100° C. to about 200° C.;
c) contacting the wood for a further heating period with a set of opposing plates at a temperature of from about 200° C. to about 320° C.

32. The method of claim 25, wherein the wood is maintained:
a) for the first period at a pressure of about 0.8 bar; and/or
b) for the third period at a pressure of about 0.8 bar.

33. The method of claim 25, wherein the aqueous resin composition comprises a phenoplast resin.

34. The method of claim 25, wherein the aqueous resin composition has a solids content of from about 1% w/w to about 50% w/w of the resin composition.

35. The method of claim 34, wherein the aqueous resin composition has a pH in excess of 9.0.

36. The method of claim 25, wherein one or more of the heating periods is for a period and at a temperature sufficient to torrefy at least 25% of the lignocellulose present in the wood.

37. The method of claim 25, wherein when the wood is maintained at from about 200° C. to about 320° C. or contacted with a set of opposing plates at a temperature of from about about 200° C. to about 320° C., or is maintained at a temperature sufficient to have the temperature at the centre of the wood to be from about 200° C. to about 320° C., the wood is maintained or contacted for a period sufficient to
a) de-hydrolyse or degrade at least about 25% w/w of the lignocellulose present in the wood prior to contact with the aqueous resin composition; or
b) degrade at least about 25% w/w of the cellulose present in the wood prior to contact with the aqueous resin composition; or
c) degrade at least about 25% w/w of the hemicellulose present in the wood prior to contact with the aqueous resin composition; or
d) degrade at least about 25% w/w of the lignin present in the wood prior to contact with the aqueous resin composition; or
e) remove at least about 10% of the volatiles present in the wood prior to contact with the aqueous resin composition; or
f) any combination of two or more of any of a) to e) above.

38. The method of claim 25, wherein the method comprises:
a) providing wood suitable for treating;
b) maintaining the wood for a first period at a pressure of from less than 1 bar to about 0.7 bar;
c) contacting the wood with an aqueous resin composition while the wood is at a pressure of from less than 1 bar to about 0.7 bar;
d) maintaining the wood for a second period at a pressure of from more than 1 bar to about 15 bar;
e) maintaining the wood for a third period at a pressure of from less than 1 bar to about 0.7 bar; and
f) heating the wood by
i. contacting the wood for a first heating period with a set of opposing plates at a temperature of from about 70° C. to about 100° C.;
ii. contacting the wood for a second heating period with a set of opposing plates at a temperature of from about 100° C. to about 200° C.;
iii. contacting the wood for a third heating period with a set of opposing plates at a temperature of from about 200° C. to about 320° C.

39. The method of claim 25, wherein the heating comprises:
a) contacting the wood for a first heating period with a set of opposing plates at a temperature sufficient to have the temperature at the centre of the wood to be from about 70° C. to about 100° C.;
b) contacting the wood for a second heating period with a set of opposing plates at a temperature sufficient to have the temperature at the centre of the wood to be from about 100° C. to about 200° C.;
c) contacting the wood for a further heating period with a set of opposing plates at a temperature sufficient to have the temperature at the centre of the wood to be from about 200° C. to about 320° C.

40. A modified wood prepared by the method of claim 25.

41. The modified wood of claim 40, wherein the modified wood comprises lignocellulose and wherein at least about 25% of the hemicellulose present in the wood prior to modification is degraded.

42. The modified wood of claim 40, wherein the modified wood comprising a resin, and wherein the modified wood
a) comprises at least about 5% w/w of one or more by-products of pyrolysis or torrefaction, or
b) comprises at least about 10% w/w lignocellulose, wherein at least about 25% w/w of the lignocellulose is de-hydrolysed; or
c) comprises at least about 10% w/w lignocellulose, wherein at least about 25% of the cellulose present in the wood prior to modification is degraded; or
d) comprises at least about 10% w/w lignocellulose, wherein at least about 25% of the hemicellulose present in the wood prior to modification is degraded; or
e) comprises at least about 10% w/w lignocellulose, wherein at least about 25% of the lignin present in the wood prior to modification is degraded; or
f) has a volatiles content of at least about 10% w/w less than the volatiles content of the wood prior to modification; or
g) any combination of two or more of any of a) to f) above.

43. A product comprising a modified wood as claimed in claim 40.

44. The modified wood of claim 40, wherein with respect to the wood prior to treatment, the modified wood has one or more of the following:
a) increased density;
b) decreased moisture by at least about 6%;
c) increased tensile strength;
d) increased hardness;
e) increased weather resistance;
f) managed colour;
g) increased durability;
h) improved fire resistance;
any combination of two or more of any of a) to h) above.
